(19) United States
(12) Patent Application Publication
(10) Pub. No.: US 2013/0225305 A1
(43) Pub. Date: Aug. 29, 2013

(54) EXPANDED 3D SPACE-BASED VIRTUAL SPORTS SIMULATION SYSTEM

(71) Applicants: Ung-Yeon YANG, Daejeon (KR); Yong-Wan Kim, Daejeon (KR); Ki-Suk Lee, Daejeon (KR); Byung-Seok Roh, Seoul (KR); Ki-Hong Kim, Daejeon (KR)

(72) Inventors: Ung-Yeon YANG, Daejeon (KR); Yong-Wan Kim, Daejeon (KR); Ki-Suk Lee, Daejeon (KR); Byung-Seok Roh, Seoul (KR); Ki-Hong Kim, Daejeon (KR)

(73) Assignee: Electronics and Telecommunications Research Institute, Daejeon (KR)

(21) Appl. No.: 13/566,928

(22) Filed: Aug. 3, 2012

(30) Foreign Application Priority Data
Feb. 28, 2012 (KR) 10-2012-0020557

(51) Int. Cl. A63B 69/36; A63F 13/00

(52) U.S. Cl. 473/152; 463/32

(57) ABSTRACT

An expanded 3D space-based virtual sports simulation system is provided. The expanded 3D space-based virtual sports simulation system includes: a plurality of user tracking devices configured to track a user's body motion; a first display device configured to display a first image including content; a second display device configured to display a second image including an image of the user's body motion tracked through the user tracking devices; and a control unit configured to set image display spaces of the respective display devices such that physical spaces for displaying an image including a 3D image are divided or shared among the respective display devices, and to provide images to the respective display devices according to a scenario.

### CROSS-REFERENCE TO RELATED APPLICATION

This application claims the benefit under 35 U.S.C. §119(a) of Korean Patent Application No. 10-2012-0020557, filed on Feb. 28, 2012, the entire disclosure of which is incorporated herein by reference for all purposes.

### BACKGROUND

1. Field

The following description relates to system technology for enabling a user to realistically experience various sports situations using an experience-based virtual reality simulation.

2. Description of the Related Art

In order to enjoy sports, individuals may learn and train specific motions and postures suitable for the relevant sports. For example, since golf is a sport that requires an accurate swing motion, methods for analyzing, guiding and correcting postures are applied. When an individual directly receives a posture correction from a private coach, qualitative evaluation may differ subjectively depending on the coach's perspective, and quantitative evaluation and analysis may be difficult. When individuals follow a coach's demonstration, there is considerable deviation in the exercise analysis process of reenacting a third party's motion on a basis of the individual's own body, depending on the individual. Hence, this method may not always be a good training method.

Quantitative analysis may be performed by analyzing a video image record and analyzing a posture using a post-processing analysis method. Also, a motion capture system may be used to analyze an accurate three-dimensional (3D) swing trajectory and a body motion. However, since a series of sequential processes, such as execution, analysis, feedback, and re-execution, is time-consuming, it is difficult to obtain immediate feedback. When posture training is conducted using a predetermined tool, only absolute 3D trajectories are repeated, without considering a user's various body conditions. Thus, this is insufficient for progress in training

An indoor screen golf system, which enables a user to experience the sport of golf in an indoor virtual reality space, has difficulty in creating a situation where a plurality of participants play a game while walking on a course. Therefore, when a plurality of participants play a game at the same time, fast progress such as in a real outdoor situation is impossible.

In the case of a two-dimensional (2D) flat image, since it is difficult to experience a feeling of distance (feeling of depth of a 3D image), a system employing a 3D image projector or 3D glasses is used. In order to compensate for an insufficient feeling of space when indoors, a screen area may be expanded using a multi-projector (2-3 or more planes), but this method has a disadvantage in that installation and operation expenses increase.

A screen golf system may realize a scenario of hitting a golf ball toward a remote space behind a physical screen area, just like a drive. However, as in the case in which a hole exists between a screen and a user, it is necessary for a user to imagine a position of a hole while watching a short-distance field which is mismatched with an image displayed on the screen.

### SUMMARY

The following description relates to an extended 3D space-based virtual sports simulation system.

In one general aspect, an expanded 3D space-based virtual sports simulation system includes: a plurality of user tracking devices configured to track a user's body motion; a first display device configured to display a first image including content; a second display device configured to display a second image including an image of the user's body motion tracked through the user tracking devices; and a control unit configured to set image display spaces of the respective display devices such that physical spaces for displaying an image including a 3D image are divided or shared among the respective display devices, and to provide images to the respective display devices according to a scenario.

Other features and aspects will be apparent from the following detailed description, the drawings, and the claims.

### BRIEF DESCRIPTION OF THE DRAWINGS

FIG. 1 is a configuration diagram of an extended 3D space-based virtual sports simulation system according to an embodiment of the present invention.

FIG. 2 is a detailed configuration diagram of a control unit according to an embodiment of the present invention.

FIGS. 3A to 3D are diagrams illustrating an example of a first scenario of an extended 3D space-based virtual sports simulation system according to an embodiment of the present invention.

FIGS. 4A to 4D are diagrams illustrating an example of a second scenario of an extended 3D space-based virtual sports simulation system according to an embodiment of the present invention.

FIGS. 5A to 5D are diagrams illustrating an example of a third scenario of an extended 3D space-based virtual sports simulation system according to an embodiment of the present invention.

FIGS. 6A to 6D are diagrams illustrating an example of a fourth scenario of an extended 3D space-based virtual sports simulation system according to an embodiment of the present invention.

FIGS. 7A to 7D are diagrams illustrating an example of a fifth scenario of an extended 3D space-based virtual sports simulation system according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

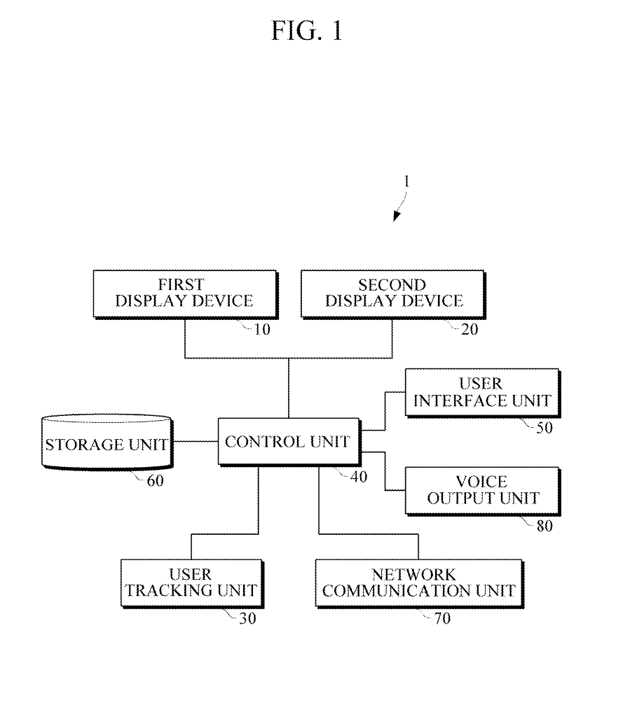

FIG. 1 is a configuration diagram of an extended 3D space-based virtual sports simulation system 1 according to an embodiment of the present invention.

The extended 3D space-based virtual sports simulation system (hereinafter, referred to as “system”) 1 includes a first display device 10, a second display device 20, a user tracking device 30, and a control unit 40. The system may further include a user interface unit 50, a storage unit 60, a network communication unit 70, and a video output unit 80.

The present invention provides virtual reality technology that enables users to experience virtual sports. In the present invention, the term “virtual reality” is used to mean technical fields including mixed reality technology and augmented reality technology. When training, educational or report services are provided using various objects existing in a real space, virtual reality technology may provide users with situations which are difficult to experience due to economical or safety problems through a virtual space, and enable users to experience such situations.

Virtual reality may enable complete realization of the feeling of experience and provide the feeling of a natural 3D space. In particular, the present invention provides a system that may overcome a limitation of general virtual reality simulation technology in expressing a feeling of 3D space, when a user enjoys, learns or trains in sports, such as golf, in a virtual space, and provide contents oriented to an individual user, enabling more efficient leisure activity, learning, and training

For this purpose, the present invention suggests an expanded 3D image display platform and expanded 3D (E3D) technology as operating technology thereof, so that multiple 3D images displayed on homogeneous or heterogeneous display devices are converged in a single 3D display space. The homogeneous or heterogeneous displays refer to displays that operate based on the same or different hardware (H/W) configuration and the same or different software (S/W) operating environment. The present invention provides a 3D image interaction space in which multiple 3D images output from the existing various 2D and 3D display devices and the newly proposed display devices are converged in a single 3D display space and integrally controlled.

The homogeneous or heterogeneous displays may be classified as stationary display devices, mobile display devices, portable display devices, and wearable display devices, depending on a distance from a user's point of view.

The stationary display device is a display that can be installed at a fixed position. Examples of the stationary display device may include TVs, 3DTVs, general projectors, 3D projectors, and the like. An image display space may be created by a single display device or a combination of a plurality of 2D and 3D display devices. By creating a Cave Automatic Virtual Environment (CAVE) type display space completely filling the walls of a space surrounding a user, a user virtual participation space may be expanded to a space transcending physical walls.

The mobile display device is mobile and may include a stationary display device which is mobile due to rotary wheels embedded therein, for example, a mobile kiosk display. The portable display device is a mobile display that can be carried by a user. Examples of the portable display device may include a mobile phone, a smart phone, a smart pad, and the like.

The wearable display device is a display that can be worn by a user. Examples of the wearable display device may include a head mounted display (HMD), which is wearable on a user's head, and an eye glassed display (EGD). The EGD may provide an immersive mixed environment by displaying a 3D image directly in front of a user's two eyes.

The first display device 10 and the second display device 20 according to the embodiment of the present invention may be any one of the stationary display device, the mobile display device, the portable display device, and the wearable display device. Each of the first display device 10 and the second display device 20 is provided with one or more display devices. The first display device 10 and the second display device 20 may be homogeneous or heterogeneous.

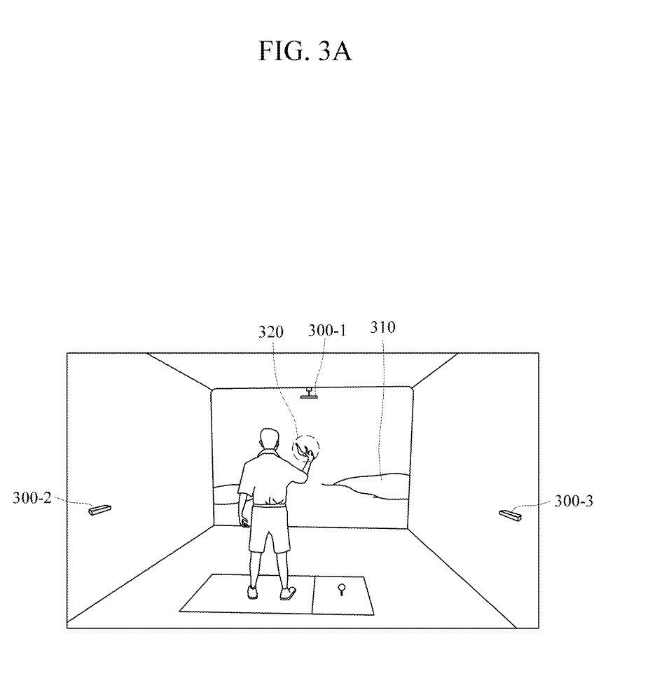

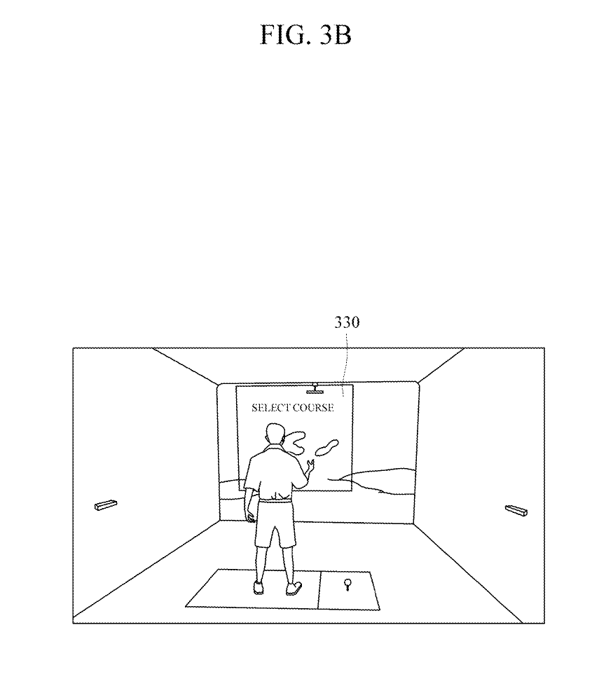

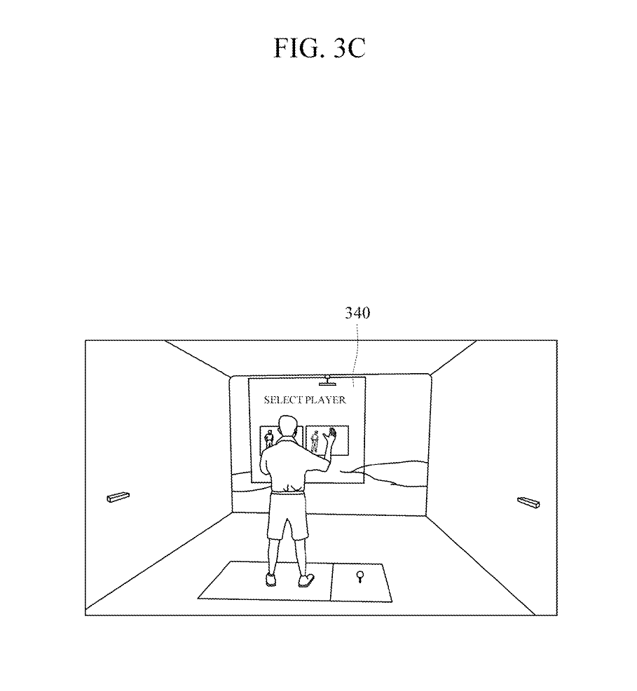

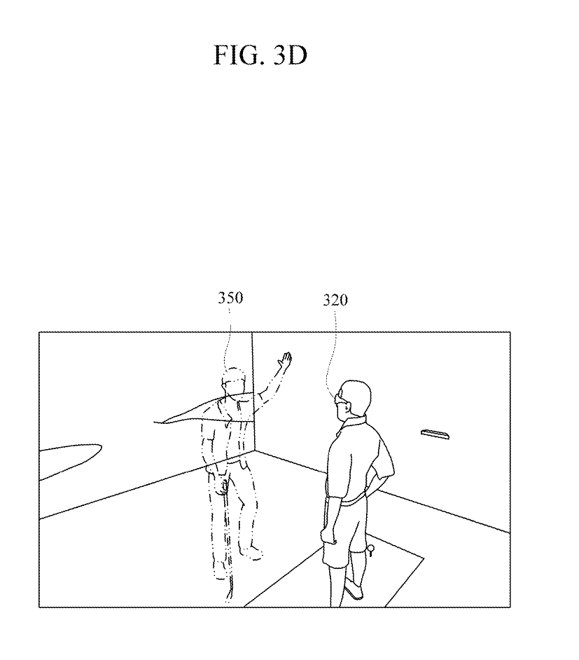

The first display device 10 displays a first image including content, and the second display device 20 displays a second image including a second image of a user body motion tracked through a plurality of user tracking devices 30, which will be described later. According to an embodiment, the first display device 10 may be a stationary display device, and the second display device may be an EGD. In this case, since the EGD is a see-through type, the first image displayed by the first display device 10 and the second image displayed by the EGD may be simultaneously displayed to a user. Embodiments that enable a user to experience virtual sports through a screen-type stationary display device and an EGD will be described later with reference to FIGS. 3 to 7.

The user tracking device 30 tracks 3D gestures of a user's whole body in real time, and extracts information on a user's joints, without a user uncomfortably wearing additional sensors or tools. The user tracking device 30 may capture a depth image of the user as well as an RGB color image of the user. The user tracking device 30 may be a 3D depth camera, for example, a Microsoft's KINECT 3D depth camera, and a plurality of user tracking devices may be provided.

The control unit 40 sets image display spaces of the respective display devices such that physical spaces for displaying an image including a 3D image are divided or shared among the display devices, and provides an image to each of the display devices 10 and 20 according to a scenario.

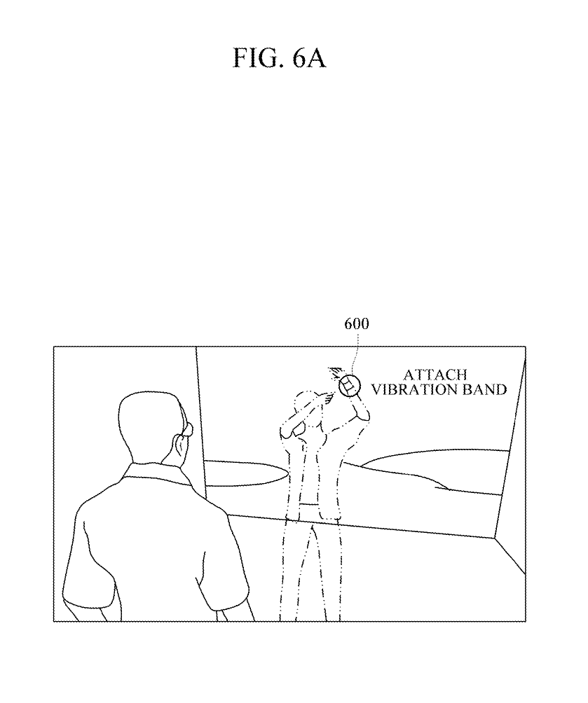

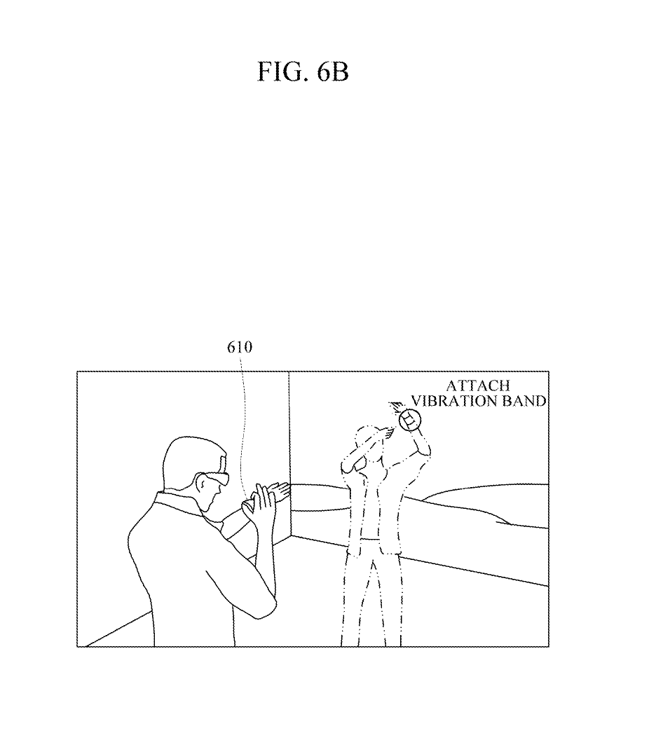

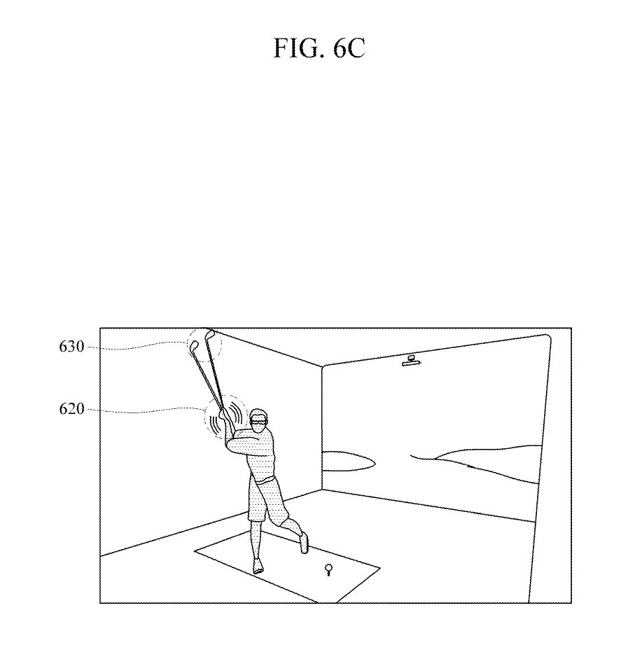

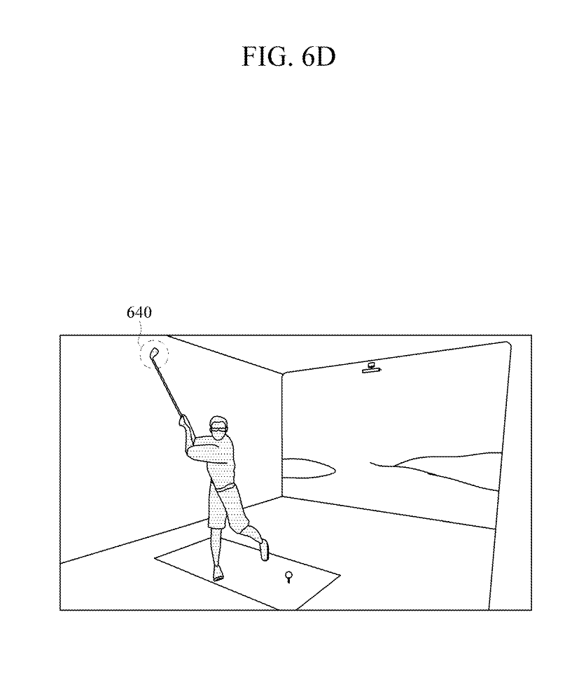

The user interface unit 50 is mounted on a user and provides a feedback with respect to a user's motion. In this case, the user interface unit 50 may provide multi-modal feedback including at least one of a sense of sight, a sense of hearing, and a sense of touch, upon user motion feedback. Usage examples of the user interface unit 50 will be described later with reference to FIGS. 6A to 6D.

The storage unit 60 sets a relationship among hardware components, software components, and ergonomic parameters related to a user's 3D image experience in advance, in order to create an image display space, and stores and manages the set information in a database structure. The storage unit 60 stores and manages content information to be provided to a user.

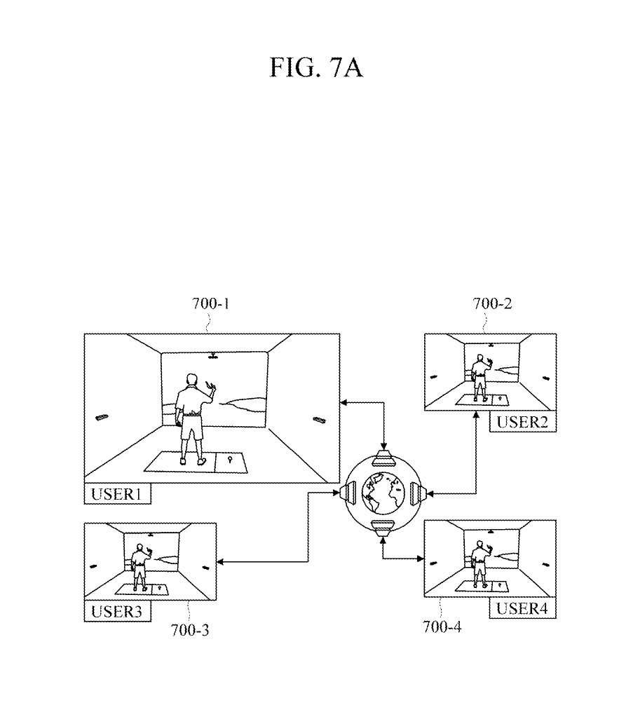

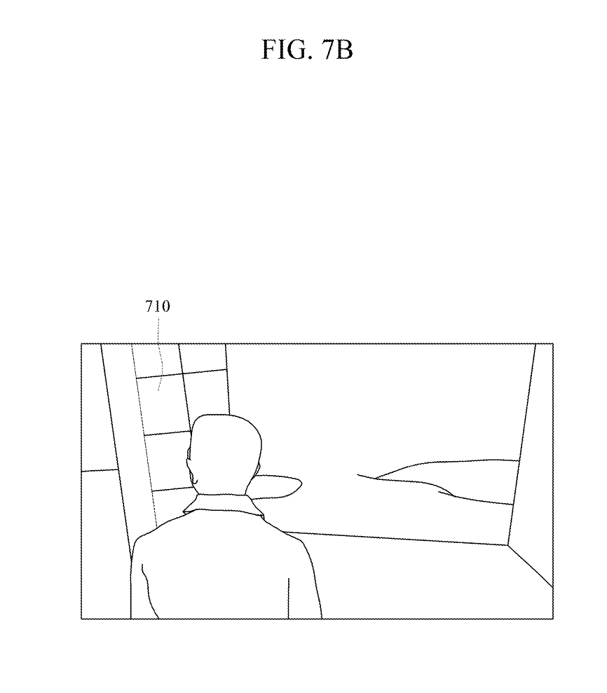

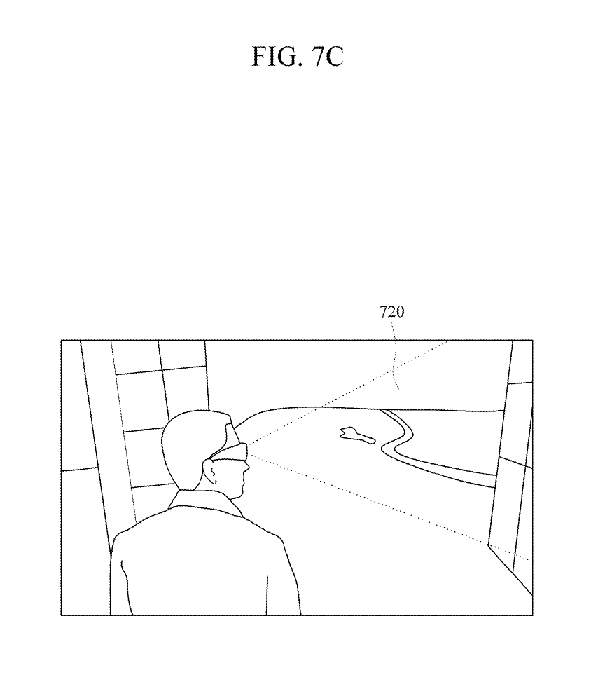

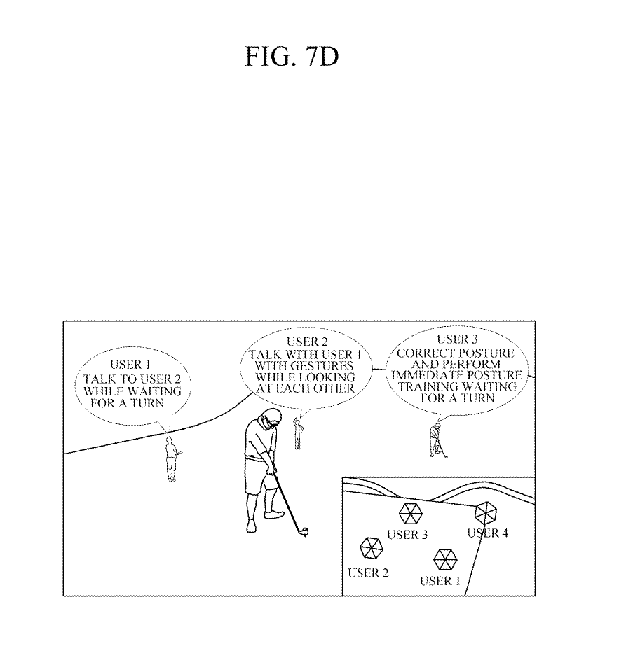

The network communication unit 70 connects other systems through a network, and supports multiple participation that allows users of other systems to participate together. Upon network connection through the network communication unit 70, the control unit 40 displays positions and motions of a plurality of users through a predetermined display device within a virtual space. Usage examples of the network communication unit 70 will be described later with reference to FIGS. 7A to 7D.

Upon network connection through the network communication unit 70, the voice output unit 80 outputs voice signals of other users, so that a first user can feel that voices are output in a direction of the first user from positions of other users located at predetermined positions according to a game progress status within the virtual space visualized through the predetermined display device. In the present invention, this is referred to as a 3D sound output scheme. An embodiment regarding this will be described later with reference to FIG. 7D.

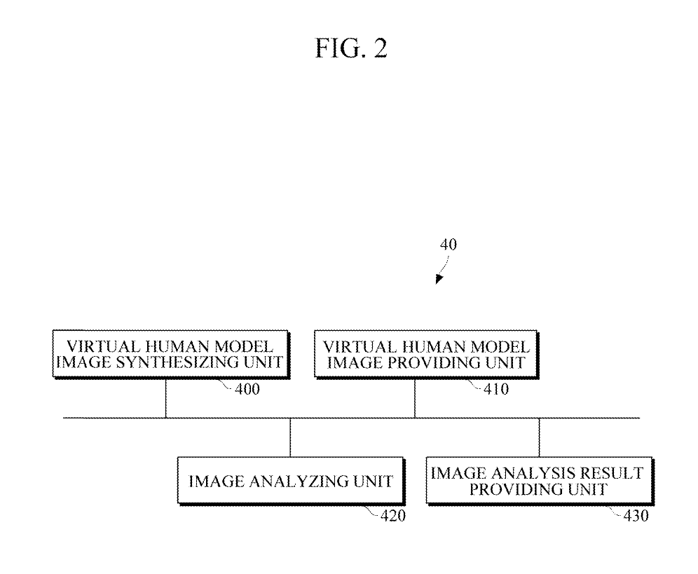

FIG. 2 is a detailed configuration diagram of the control unit 40 according to an embodiment of the present invention.

According to an embodiment, the control unit 40 includes a virtual human model image synthesizing unit 400, a virtual human model image providing unit 410, an image analyzing unit 420, and an image analysis result providing unit 430.

The virtual human model image synthesizing unit 400 integrates a virtual human model image and a user's body motion area image by superimposing a virtual human model image for guiding a user's body motion with a user's body motion image tracked through the plurality of user tracking devices. The virtual human model may be optimized to the same size as the user's body.

The virtual human model image providing unit 410 displays the virtual human model image or the superimposed image, provided by the virtual human model image synthesizing unit 400, on a predetermined display device. For example, the superimposed image may be displayed in the image display space of the EGD the user wears.

The image analyzing unit 420 compares and analyzes the virtual human model image and the user's body motion image. The image analysis result providing unit 430 displays the analysis result obtained through the image analysis unit 420 on a predetermined display device. When the virtual human model image does not match the user's body motion image, the image analysis result providing unit 430 may provide correction information such that the user's body motion matches the virtual human model.

Hereinafter, scenarios and processes for applying the system 1 having the configuration of FIGS. 1 and 2 to the sport of golf will be described later with reference to FIGS. 3 to 7.

FIGS. 3A to 3D are diagrams illustrating an example of a first scenario of the system 1 according to an embodiment of the present invention.

Referring to FIG. 3A, the user tracking devices 300-1, 300-2 and 300-3 are used to track a 3D gesture of a user's whole body and extract information on a user's joints. If using the user tracking devices 300-1, 300-2 and 300-3, it is unnecessary for the user to uncomfortably wear additional sensors or tools.

Information on a skeletal structure of the user's whole body may be acquired through the user tracking devices 300-1, 300-2 and 300-3 in real time. However, in the case of using only one user tracking device, it is difficult to acquire body information on an opposite side of a camera due to a limited camera view volume and a line-of-sight characteristic. Therefore, as illustrated in FIG. 3A, a marker-free sensor-based whole-body motion capture system is configured using a plurality of user tracking devices at the same time.

As indicated by reference numeral 310, the system 1 displays an external content image through a stationary display device, for example, a 2D or 3D projector, and displays an individual image exposed to an individual user through a wearable display device, for example, an EGD 320. Since the EGD 320 basically provides a see-through image, the user may simultaneously experience the user's own body motion and the content provided from the system 1 together with an external environment such as a golf club. According to another embodiment, the system 1 further includes a 3D surround sound system using a multi-speaker set capable of expressing a 3D position of a specific object.

When the system 1 is operated and the user wears the EGD 320, as illustrated in FIG. 3B, a 3D GUI menu 330 is displayed on an image display space that is within the user's reach. The user experiences a virtual golf service while selecting a predetermined menu. For example, the predetermined menu may be a course, a user, or the like. As indicated by reference numeral 340, the predetermined menu may be selected using a gesture interaction, which recognizes a user's gesture, a voice recognition interface, or the like.

Referring to FIG. 3D, in the case of a golf posture training step, when the user selects a virtual human model 350, for example, a professional golfer, as a 1:1 private coach, a virtual human model image is displayed in an image display space. The virtual human model image is provided for training the user, and contains a professional golfer's exemplary motions for guiding a user's body motion. The virtual human model image may be prestored in the storage unit 60 of FIG. 1.

As illustrated in FIG. 3D, the image display space proposed by the virtual human model may be a 3D space close to the user, or a space displayed through the EGD 320. In this case, superposition may be performed such that the virtual human model image and the user's motion area image are integrally displayed. Also, the virtual human model may be optimized to the same size as the user's body area. When the virtual human model is integrated with the user's body area in the first person, the user may feel as if a ghost overlaps the user's body area. Furthermore, the system 1 may compare and analyze the virtual human model and the user's motion information input from the user tracking devices 300-1, 300-2 and 300-3 of FIG. 3A, and provide the analysis result to the user in real time. If necessary, the virtual human model may transfer guide information to the user through the voice output interface. In the interaction based on the ghost-metaphor, the roles of the trainer and the learner may be exchanged with each other. For example, in the system connected through the network, the virtual human model acts as the user, and the user is visualized as the virtual human model and may perform a training operation using an on-line voice channel, while viewing an image of the EGD in the first person of the virtual human model.

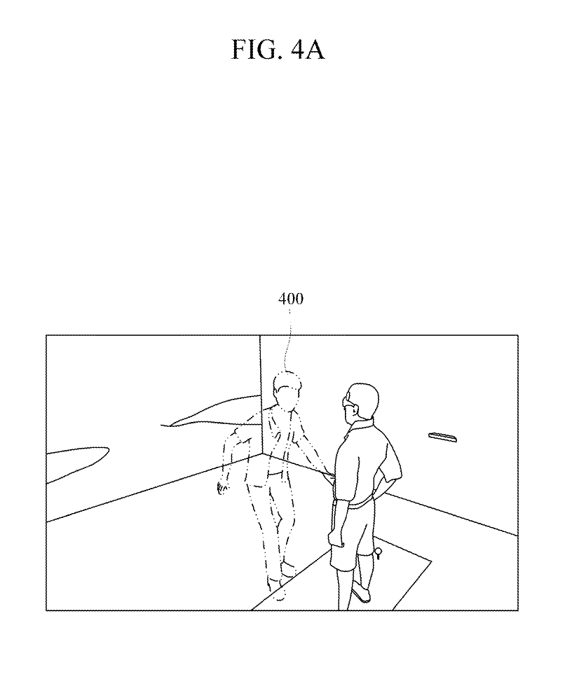

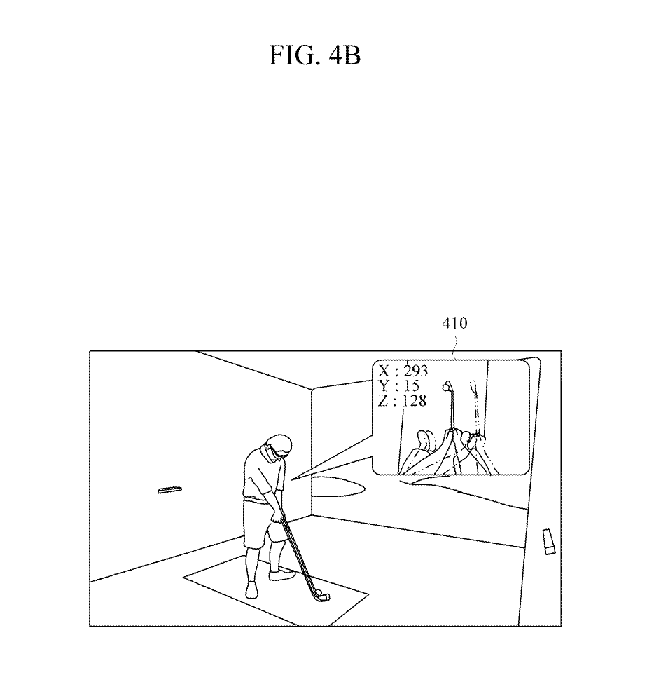

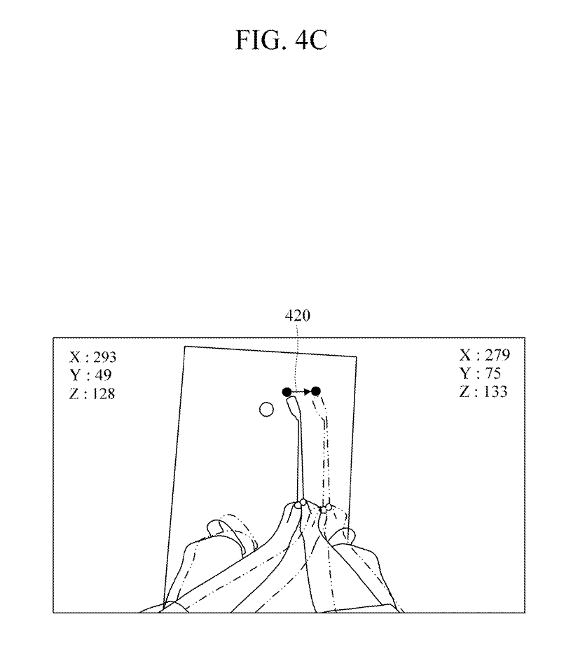

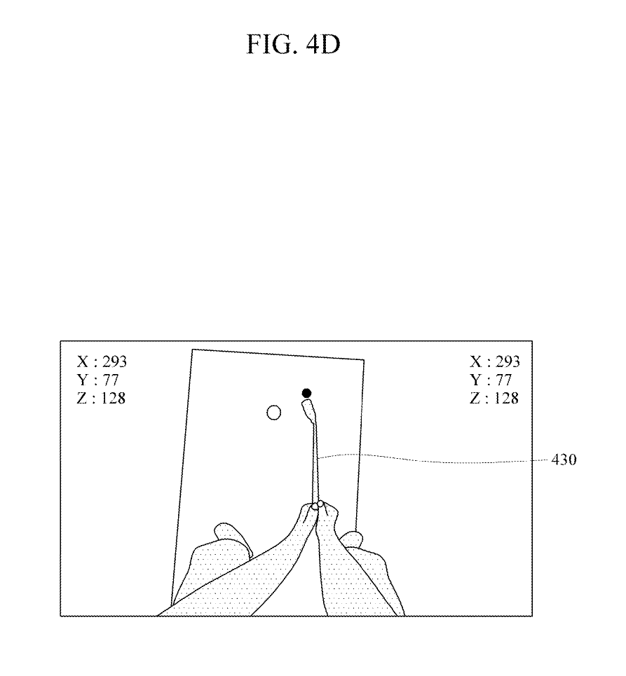

FIGS. 4A to 4D are diagrams illustrating an example of a second scenario of the system 1 according to an embodiment of the present invention.

Referring to FIG. 4, as indicated by reference numeral 400, a virtual human model for guiding a user's body motion may be displayed in an image display space that is within the user's reach. Furthermore, a virtual human model may be superimposed with a user's body motion image tracked through a plurality of user tracking devices, so that the virtual human model image and the user's body motion area image are integrated.

Referring to FIG. 4B, as indicated by reference numeral 410, when the virtual human model and the user's body motion image are integrated, the integrated image may be visualized through the EGD the user wears. Therefore, the user can check a correct golf posture of a processional golfer, which is a virtual human model, in terms of the first person. In reference numeral 410, a body indicated by a solid line represents a user object, and a body indicated by a dotted line represents a virtual human model.

Referring to FIG. 4C, the system 1 may compare and analyze a virtual human model image and a user's body motion image, and display the analysis result on a predetermined display device. In this case, when the virtual human model image does not match the user's body motion image, correction information may be provided such that the user's body motion matches the virtual human model. For example, as indicated by reference numeral 420 of FIG. 4C, the correction information may be displayed through the GUI. Alternatively, the correction information may be provided through voice.

Reference numeral 430 of FIG. 4D shows a case in which the user's body motion matches the virtual human model according to the correction information described above with reference to FIG. 4C. Since the user acquires feedback information on the correction of golf postures in the user's own point of view, it is possible to reduce time and effort to reach the step of realizing the motion matched with the posture of the professional golfer, which is the virtual human model.

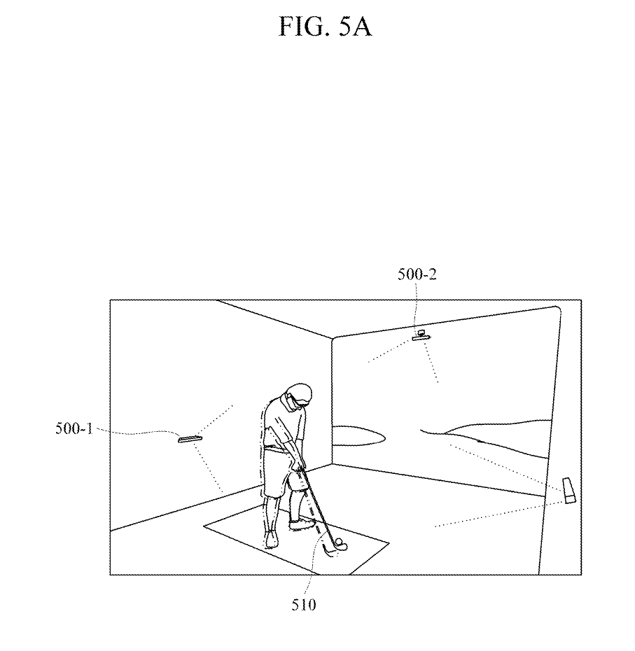

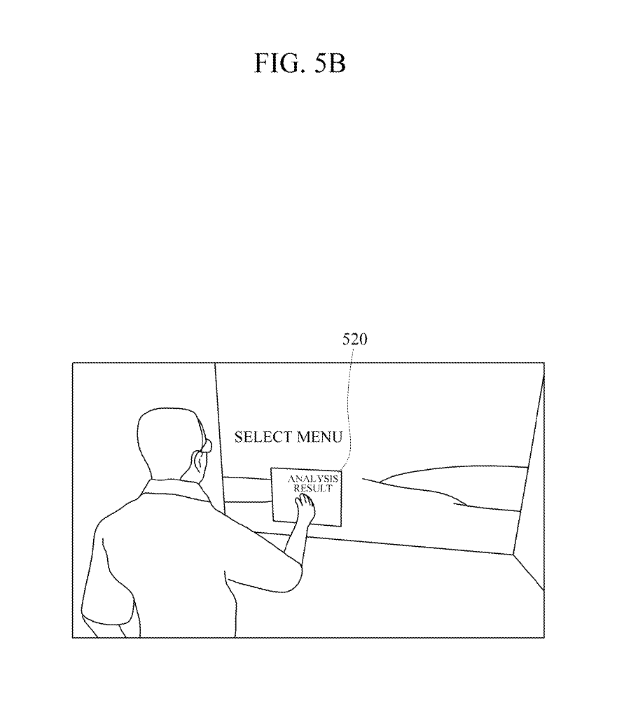

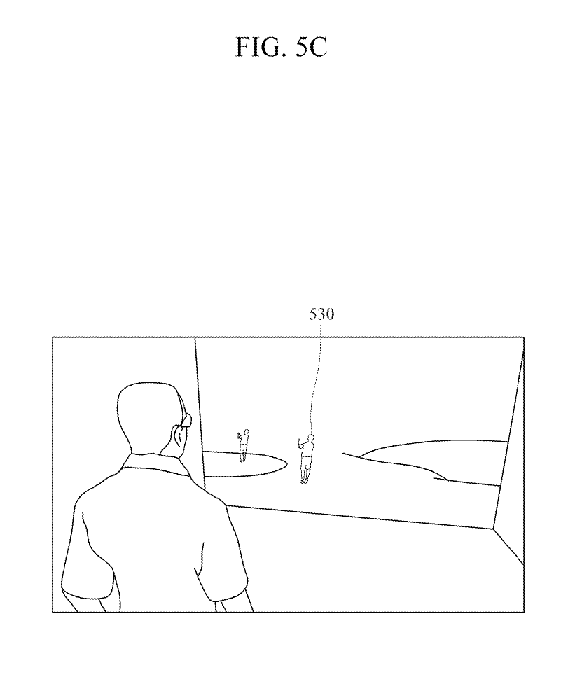

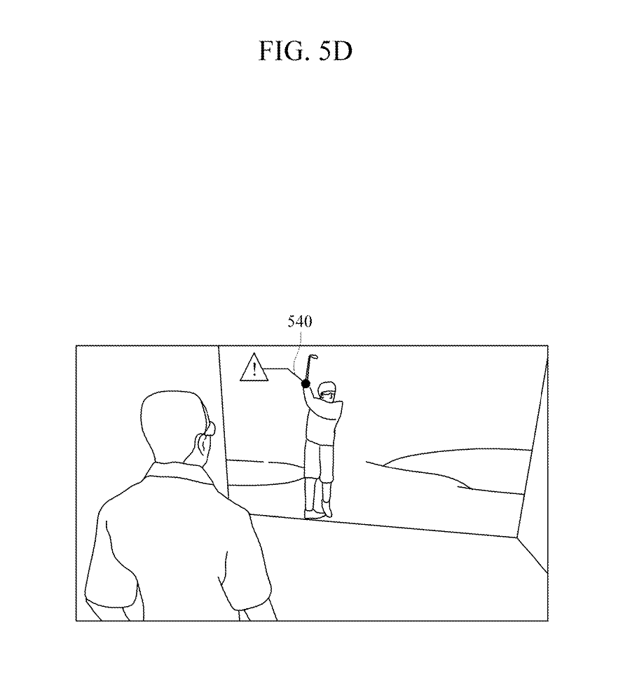

FIGS. 5A to 5D are diagrams illustrating an example of a third scenario of the system 1 according to an embodiment of the present invention.

Referring to FIG. 5A, the system 1 tracks a gesture of a user's whole body through ae plurality of user tracking devices 500-1 and 500-2. Since a sensor is built into a golf club 510, six degrees of freedom (6 DOF) with respect to the golf club 510 and a user force applied to the golf club 510 may be detected. The 6 DOF includes X/Y/Z position values and pitch/yaw/roll angle values.

Referring to FIGS. 5B and 5C, as indicated by reference numerals 520 and 530, when the user performs a golf swing, the system 1 may analyze the user's golf swing motion and display the analysis result in a predetermined image display space. That is, when the user's golf swing motion is tracked through the plurality of user tracking devices 500-1 and 500-2 (FIG. 5A) and the golf club 510 (FIG. 5A) with the built-in sensor, the system may analyze a difference between the user's golf swing motion and a professional golfer's golf swing motion and display the analysis result. In this case, contents the user needs to correct intensively with reference to the professional golfer's swing motion may be displayed in the predetermined image display space. For example, as indicated by reference numeral 540 of FIG. 5D, a case indicating a moment the user excessively twists his or her wrist during the swing motion is displayed.

FIGS. 6A to 6D are diagrams illustrating an example of a fourth scenario of the system 4 according to an embodiment of the present invention.

Referring to FIGS. 6A to 6D, the system 1 includes a user interface unit mounted on a user to provide feedback with respect to a user motion. The feedback with respect to the user motion is provided for analyzing and correcting a user posture.

In this case, the user interface unit may provide multi-modal feedback including at least one of a sense of sight, a sense of hearing, and a sense of touch, upon user motion feedback. For example, the user interface is a band-type haptic interface unit with a built-in haptic stimulator. In order to provide additional feedback for parts requiring intensive training, the system 1 may suggest haptic stimulation (for example, vibration, electrical stimulation, or the like) to the user, or may output voice information to the user.

For example, as illustrated in FIG. 6A, the system 1 informs the user of attaching the user interface (for example, vibration band). When the user attaches the user interface as illustrated in FIG. 6B, the system 1 may provide visual, voice and haptic feedback so that the user can correct postures at a specific moment and position as illustrated in FIG. 6C. FIG. 6C illustrates an example in which haptic feedback is provided, as indicated by reference numeral 620, when it is determined that the user's posture is inappropriate because the user's body motion does not match the motion of the virtual human model as indicated by reference numeral 630. As indicated by reference numeral 640 of FIG. 4D, the user can accept the feedback and correct the posture.

Reference numeral 600 of FIG. 6A and reference numeral 610 of FIG. 6B inform the user of mounting the user interface, and reference numeral 630 of FIG. 6C shows that the user's swing motion does not match the professional golfer's swing motion. Reference numeral 620 of FIG. 6C shows an example that provides haptic feedback, and reference numeral 640 of FIG. 6D shows that, due to the correction of the user's posture, the user's swing motion matches the professional golfer's swing motion.

FIGS. 7A to 7D are diagrams illustrating an example of a fifth scenario of the system 1 according to an embodiment of the present invention.

Referring to FIGS. 7A to 7D, the system 1 may be connected to other systems through the network to provide a situation such as a plurality of participants simultaneously playing a game in a single outdoor course online.

Referring to FIG. 7A, systems 700-1, 700-2, 700-3 and 700-4 are interconnected through the network and users 1, 2, 3 and 4 share a single virtual field, so as to support the experience on an outdoor course in which a plurality of users simultaneously participate. In this way, as indicated by reference numerals 710 and 720 of FIGS. 7B and 7C, when the user wearing the EGD looks around, an outdoor field image is continuously displayed in a virtual screen golf space. As illustrated in FIG. 7D, other users participating in the network in the same position and direction as the golf progress state in the outdoor field are displayed. The user's conversation is provided to other users through the system 1 using a 3D sound output technique. Therefore, the users can feel as if voice is output from the positions and directions of other users located in the outdoor field.

Reference numeral 710 of FIG. 7B shows an image displayed when a multiple participant outdoor field mode is activated, a stationary display device located in front is expanded when the user looks around, and a virtual outdoor field is unfolded in all space surrounding the user. Reference numeral 720 of FIG. 7C shows an image displayed when an internal image output from the EGD and an external image observed in a surrounding environment are selectively synthesized. FIG. 7D shows an image displayed when the user 4 view the users 1, 2 and 3 in the virtual outdoor field. The images of other users displayed on the screen may be restored digital virtual avatars of the users tracked through the user tracking device, for example, a plurality of 3D depth cameras, or may be actual video images of the users extracted using chromakey technology or video processing technology for separating a dynamic object from a still image.

According to one embodiment, an expanded 3D space-based virtual sports simulation system may overcome a limitation of a virtual reality simulation system in expressing a feeling of 3D space, and may realize a more efficient studying and training system by providing content information oriented to individual users.

Furthermore, the expanded 3D space-based virtual sports simulation system may provide an interface to establish a plurality of expanded 3D space-based homogeneous and heterogeneous display platforms in a designated space, track a user's physical motion, and provide multi-modal feedback, such as a sense of sight, a sense of hearing, a sense of touch, and the like.

The expanded 3D space-based virtual sports simulation system may be widely applied to the fields of various sports including a virtual golf system, entertainment, educational and military training simulations, and the like.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An expanded 3D space-based virtual sports simulation system, comprising:
a plurality of user tracking devices configured to track a user's body motion;
a first display device configured to display a first image including content;
a second display device configured to display a second image including an image of the user's body motion tracked through the user tracking devices; and
a control unit configured to set image display spaces of the respective display devices such that physical spaces for displaying an image including a 3D image are divided or shared among the respective display devices, and to provide images to the respective display devices according to a scenario.

2. The expanded 3D space-based virtual sports simulation system of claim 1, wherein the user tracking devices are a plurality of 3D depth cameras.

3. The expanded 3D space-based virtual sports simulation system of claim 1, wherein the control unit comprises:
a virtual human model image synthesizing unit configured to integrate a virtual human model image and a user's body motion area image by superimposing the virtual human model image for guiding a user's body motion with the user's body motion image tracked through the plurality of user tracking devices; and
a virtual human model image providing unit configured to display the virtual human model image or the image superimposed through the virtual human model image synthesizing unit on a predetermined display device.

4. The expanded 3D space-based virtual sports simulation system of claim 3, wherein a training posture for training a user is reflected in the virtual human model.

5. The expanded 3D space-based virtual sports simulation system of claim 3, wherein the virtual human model image synthesizing unit optimizes the virtual human model to the same size as a user's body.

6. The expanded 3D space-based virtual sports simulation system of claim 3, wherein the control unit further comprises:
an image analyzing unit configured to compare and analyze the virtual human model image and the user's body motion image; and
an image analysis result providing unit configured to display an analysis result of the image analyzing unit on a predetermined display device.

7. The expanded 3D space-based virtual sports simulation system of claim 6, wherein when the virtual human body image does not match the user's body motion image, the image analysis result providing unit provides correction information for matching the user's body motion with the virtual human model.

8. The expanded 3D space-based virtual sports simulation system of claim 1, wherein the first display device is a stationary display device, and the second display device is an eye glassed display device.

9. The expanded 3D space-based virtual sports simulation system of claim 8, wherein the eye glassed display device is a see-through type to simultaneously display the first image and the second image to the user.

10. The expanded 3D space-based virtual sports simulation system of claim 1, further comprising a user interface unit mounted on a user and configured to provide feedback with respect to a user's motion.

11. The expanded 3D space-based virtual sports simulation system of claim 10, wherein the user interface unit provides multi-modal feedback including at least one of a sense of sight, a sense of hearing, and a sense of touch, upon user motion feedback.

12. The expanded 3D space-based virtual sports simulation system of claim 1, further comprising a network communication unit configured to connect other systems through a network and support multiple participation which allows users of the systems to participate.

13. The expanded 3D space-based virtual sports simulation system of claim 12, wherein when the network is connected by the network communication unit, the control unit virtualizes positions and motions of the plurality of users within a virtual space through a predetermined display device.

14. The expanded 3D space-based virtual sport simulation system of 13, wherein the control unit visualizes the positions and motions of other users participating in the network within the virtual space through the predetermined display device, so that the user can view the other users as an audience.

15. The expanded 3D space-based virtual sports simulation system of 13, wherein the control unit visualizes the positions and motions of the user and the other users participating in the network within the virtual space through the predetermined display device, so that the user can participate in the network as a player.

16. The expanded 3D space-based virtual sports simulation system of claim 13, further comprising: a voice output unit configured to output voice signals of other users, so that a first user feels that voice is output in a direction of the first user from predetermined positions of other users according to a game progress status within the virtual space visualized through the predetermined display device.

17. The expanded 3D space-based virtual sports simulation system of claim 1, further comprising a sensor mounted on or built into the user's body or a tool held by the user and configured to detect six degrees of freedom and forces with respect to the user.
